(19) United States
(12) Patent Application Publication
(10) Pub. No.: US 2008/0267738 A1
(43) Pub. Date: Oct. 30, 2008

(54) Apparatus and method for combining a number of portions of a product in a stick shape, in pieces or in the shape of free-flowing particles and for synchronized transfer of the portions to a packaging apparatus

(75) Inventors: Andreas Hollmann, Dettenheim (DE); Manfred Rau, Wetzlar (DE)

Correspondence Address: PYLE & PIONTEK;ATTN: THOMAS R. VIGIL, 221 N LASALLE STREET , ROOM 2036, ROOM 2036, CHICAGO, IL, 60601, US

(73) Assignee: Hastamat Verpackungstechnik GmbH, Lahnau (DE)

(21) Appl. No.: 12/077,711

(22) Filed: Mar. 20, 2008

(30) Foreign Application Priority Data
Apr. 24, 2007 (DE) 10 2007 019 246.2

(51) Int. Cl. G01G 13/24

(52) U.S. Cl. 414/21; 414/800

(57) ABSTRACT

The subject matter of the invention is an apparatus for combining a number of portions of a product in the shape of sticks, in pieces or in the form of free-flowing particles and for synchronized transfer of the portions to a packaging apparatus, a portion combination scale (12) being mountable upstream of said apparatus, with a product slide (22) for each weighing bowl (18) of the portion combination scale (12) for receiving and transferring the portion coming from the weighing bowl (18) and with a hopper (32) for collecting the number of portions and for transfer to a packaging apparatus. Providing such a higher capacity apparatus is achieved by providing, between said product slide (22) and said hopper (32), at least one transfer chamber (26) into which said product slide (22) leads the portion coming from said weighing bowl (18).

### CROSS-REFERENCE TO RELATED APPLICATIONS

This application claims Priority from German Application No. DE 10 2007 019 246.2-27 filed on 24 Apr. 2007

### BACKGROUND OF THE INVENTION

1. Field of the Invention

The present invention relates to an apparatus as set forth in the preamble of claim 1 and to a method as set forth in the preamble of claim 7.

2. Description of the Prior Art

An apparatus for combining a number of portions of a stick-shaped product which is connected to a portion combination scale is known from DE 198 07 775 A1. A certain number of the stick-shaped products (here salt sticks) are supplied to the dosing scale pan and as soon as said dosing pan contains a sufficient portion, it is transmitted to a respective weighing bowl in which it is accurately weighed. Such a portion combination scale may comprise up to 32 individual dosing pans and weighing bowls, 16 dosing pans and 16 weighing bowls being preferably provided. After the various portions have been weighed in the weighing bowls, those weighing bowls are selected the portions of which have a total weight approximating as close as possible the target weight of the product to be packaged. Then, the selected weighing bowls are opened and the stick-shaped products fall onto slides disposed there beneath from where they are led into a suited packaging receptacle such as a bag or a box. Whilst the stick-shaped products glide into the packaging, the emptied weighing bowls are filled again so that the procedure may be repeated. The capacity of the line is naturally limited since the stick-shaped products, in particular the salt sticks, need a certain time to glide on the slide into the receptacle with the length of a cycle being determined by the slowest products.

### BRIEF SUMMARY OF THE INVENTION

In view thereof, it is the object of the present invention to increase the capacity of the apparatus mentioned herein above. The present invention relies on the observation that, if the path of the fall is shortened, the duration of one single cycle may be shortened as well so that more cycles may be performed in a given time, this increasing the capacity of the line.

As a technical solution to this object, there is proposed, in accordance with the invention, an apparatus having the features of claim 1 and a method having the features of claim 7. Advantageous developed implementations of this apparatus and of this method are recited in the respective dependent claims.

An apparatus configured in accordance with this technical teaching and a method implemented in accordance with this technical teaching offer the advantage that the transfer chambers disposed beneath the portion combination scale allow for shorter paths for the product to fall with the shorter path of fall allowing a faster cycle, this leading to an increase in the capacity of the overall line.

Another advantage is that the portions are no longer selected in the weighing bowl but in the transfer chambers. As a result, the weighing bowl may be re-filled whilst the portions are still assembled in groups and the various products are delivered to the packaging unit. Through this parallel work, the respective cycle is further shortened, which still further increases the capacity of the line.

Still another advantage is that the number of possible combinations is for example doubled in the case of two transfer chambers. Analogous applies in the case of three transfer chambers for each weighing bowl and so on. This increased number of combination possibilities allows achieving the target weight with more accuracy so that the packager of these stick-shaped, piece-shaped or free-flowing products is capable of planning and calculating with more precision.

In a preferred embodiment, the transfer of the weighed portions to each of the selected transfer chambers, the unlocking of the transfer chambers and, as a result thereof, the delivery of the portions to a packaging unit occur simultaneously so that the various products are transferred in parallel and, as a result thereof, concurrently from the weighing bowl to the transfer chamber and from the transfer chamber to the packaging unit, this leading to an even shorter cycle and to a further increase in the capacity of the line.

In another preferred embodiment, the selected transfer chambers are opened simultaneously in step c. Thus, the products may glide to the packaging unit and be packaged at the same time. This is advantageous in the case of stick-shaped products such as salt sticks in order to prevent said salt sticks from accidental stacking.

In still another preferred embodiment, the selected transfer chambers are opened one after the other in step c. The advantage thereof is that the products gliding toward the packaging unit will not arrive simultaneously at the narrowest site, namely the packaging, and cause a collision but that the products will glide one after the other into the packaging instead.

In still another preferred embodiment, the product slide is configured to be a product switch and it has been found advantageous to pivotally mount the product slide so that the end of the product slide may be pivoted so as to lead to the transfer chamber located downstream thereof for the product to enter into it. As a result, the provided product switch is of a favourable construction and still functional.

Further advantages of the apparatus of the invention and of the method of the invention will become apparent in the appended drawings and in the following description of embodiments thereof. Likewise, the invention lies in each and every novel feature or combination of features mentioned above or described herein after. The embodiments discussed herein are merely exemplary in nature and are not intended to limit the scope of the invention in any manner.

### BRIEF DESCRIPTION OF THE DRAWING

FIG. 1 shows a schematic illustration of an apparatus of the invention in a side view which is connected to a portion combination scale;

FIG. 2 a sectional top view of the apparatus as shown in FIG. 1, taken along the section line II-II in FIG. 1;

FIG. 3 an enlarged detail view of a product switch and of two transfer chambers of the apparatus shown in FIG. 1 mounted downstream thereof.

### DETAILED DESCRIPTION OF THE INVENTION

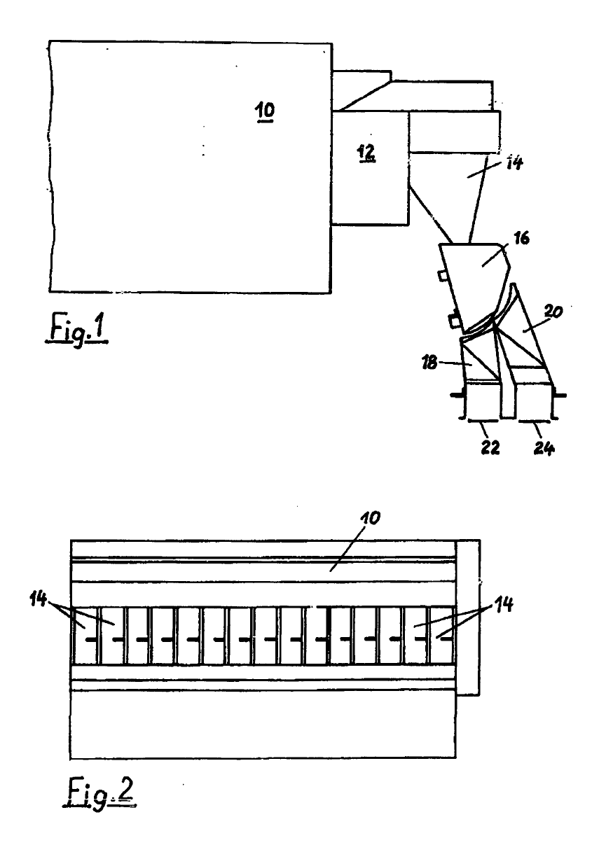

In the FIGS. 1 through 3, there is shown an apparatus of the invention for combining a number of portions of a product in stick shape, in pieces or in the shape of free-flowing particles and for synchronized transfer of the portions 10, said apparatus being connected to a portion combination scale 12. This apparatus 10 is adjoined with a packaging unit 14 in which the stick or piece-shaped or free-flowing product is packaged. The apparatus illustrated herein is a salt stick packaging line.

By means of an apparatus that has not been described in closer detail herein, the stick-shaped products are transferred into a number of dosing pans 16 so that a portion of the stick-shaped products enters each dosing pan 16. 16 dosing pans in all are evenly spaced on the circumference of the portion combination scale 12. Each dosing pan 16 is associated with a weighing bowl 18 in which the portion is accurately weighed. On the output side, each weighing bowl 18 is closed with a lock 20 and each weighing bowl 18 can be opened or closed individually.

The apparatus for combining and transferring the portions comprises sixteen product slides 22 so that each weighing bowl 18 is allocated its own product slide 22. This product slide 22 extends as far as a product bowl 24 that flares into a funnel shape in its upper part so that the product slide 22 extends into the funnel-shaped region of the product bowl. Inside, the product bowl comprises two transfer chambers 26 and each transfer chamber 26 can be opened and closed individually through a locking system 28 of its own. This locking system 28 includes a bolt disposed transverse to the opening of the transfer chamber 26 and underneath same. To open the transfer chamber 26, the bolt is quickly pulled back in order to completely clear the opening.

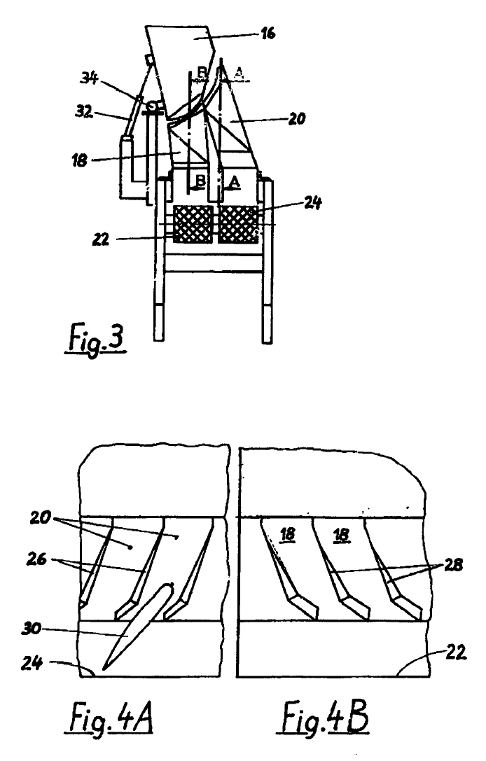

As can be seen in particular from FIG. 3, the product slide 22 is pivotally mounted in its upper part so that the product slide 22 concurrently acts as a product switch 30. According to need, the product slide 22 may lead the product sliding thereon into the right or into the left transfer chamber 26. This occurs by pivoting the product slide 22 into the respective desired position.

Beneath the product bowls 24, or the transfer chambers 26 respectively, there is provided a hopper 32 that delivers the products sliding downward to the packaging unit 14 where these products are packaged so as to be ready for dispatch.

In the case of the line shown herein, the portion combination scale 12 possesses sixteen dosing pans 16 and sixteen weighing bowls 18 so that the apparatus 10 also comprises sixteen product slides 22 and sixteen product bowls 24. In accordance with the invention, 32 transfer chambers 26 are available, though. This increased number of transfer chambers allows for selecting a greater number of portions so that the target weight may be achieved with much greater accuracy.

Shifting the choice of combinations from the weighing bowls 18 to the transfer chambers 26 further has the advantage that the weighing bowls 18 may already be filled whilst the individual portions are being selected and that the portions are weighed immediately. Through this parallel operation, the cycle for packaging a quantity of products is considerably reduced, this increasing the capacity of the entire line.

Herein after, the product packaging procedure is described in detail.

At first, the stick-shaped products, here the salt sticks, are apportioned in the dosing pans and weighed in the weighing bowls 28. The products or the portions remain in the weighing bowl 18 until the lock 20 is opened. Once the lock 20 has been opened, the stick-shaped products of the respective weighing bowl 18 slide on the corresponding product slide 22 into a transfer chamber 26 in the product bowl 24. This transfer chamber 26 is closed by an individual lock 28 so that the stick-shaped products are allowed to rest therein.

In the weighing bowls 18, the weight of the portion is electronically registered and this weight is then allocated to the respective transfer chamber 26 so that the weight of the portion located in the respective transfer chamber 26 is known any time.

Now, a number of portions are selected from the 32 transfer chambers 26 the total weight of which approximates as close as possible the target weight. As soon as these selected portions have been registered, the locking systems 28 of the respectively selected transfer chambers 26 open so that the portions located therein enter the packaging unit 14 via the hopper 32 where they can be packaged. The locking systems 28 of the selected transfer chambers 26 open simultaneously, thus preventing the stick-shaped products, the salt sticks in the present case, from stacking during their slide through the hopper 32 into the package.

In another embodiment that has not been shown herein, the locking systems 28 of the selected transfer chambers 26 open in fast sequence for the products contained in the transfer chambers to be capable of sliding one after the other through the hopper 32 into the package. Such a way of proceeding is advantageous for products that risk getting jammed at the end of the hopper 32.

Almost concurrently with the opening of the locking systems 28 of the selected transfer chambers 26, the product slides 22 acting as the product switch 30 are pivoted such that the next portion is now allowed to enter the now empty transfer chamber 26. The locks 20 of the weighing bowls 18 needed for filling the selected and now empty transfer chambers 26 also open almost at the same time so that new portions of the stick-shaped product are allowed to slide into the just emptied transfer chambers 26 whilst the selected portions are still sliding into the packaging unit 12.

Thanks to such a parallel work, the duration of a loading cycle can be considerably reduced so that, in a determined period of time, much more stick-shaped products can be packaged than in conventional lines.

### LIST OF NUMERALS

10 Apparatus

12 Portion combination scale

14 Packaging unit

16 Dosing pan

18 Weighing bowl

20 Lock

22 Product slide

24 Product receptacle

26 Transfer chamber

28 Locking system

30 Product switch

32 Hopper

We claim:

1. An apparatus for combining a number of portions of a product in the shape of sticks, in pieces or in the form of free-flowing particles and for synchronized transfer of the portions to a packaging apparatus, a portion combination scale (12) being mountable upstream of said apparatus, with a product slide (22) for each weighing bowl (18) of the portion combination scale (12) for receiving and transferring the portion coming from the weighing bowl (18) and with a hopper (32) for collecting the number of portions and for transfer to a packaging apparatus,
characterized in that, between said product slide (22) and said hopper (32), there is provided at least one transfer chamber (26) into which said product slide (22) leads the portion coming from said weighing bowl (18).

2. The apparatus as set forth in claim 1, characterized in that each product slide (22) is allocated at least two transfer chambers (26) and that said product slide (22) is configured to be a product switch (30) for said product slide (22) to be capable of allocating one portion to each of the transfer chambers (26) mounted downstream thereof.

3. The apparatus as set forth in claim 1,
characterized in that each transfer chamber (26) comprises an autonomous locking system (28) on its output side.

4. The apparatus as set forth in claim 3,
characterized in that the locking system (28) is configured to be a bolt that is preferably disposed transverse to the direction of fall of the portion.

5. The apparatus as set forth in claim 1,
characterized in that the product slide (22) is mounted for pivotal movement at or near its upper edge.

6. The apparatus as set forth in claim 1,
characterized in that the transfer chamber (26) is of an enlarged configuration on the input side.

7. A method of combining a number of portions of a product in the shape of-sticks, in pieces or in the form of free-flowing particles and for synchronized transfer of the portions to a packaging apparatus by which a plurality of portions are weighed concurrently in a portion combination scale (12), each portion being weighed in a weighing bowl (18) of its own,
characterized by the following steps:
a) transferring the weighed portions from the weighing bowls (18) to a respective one of the transfer chambers (26),
b) selecting a number of transfer chambers (26) the portions of which have together a weight approximating as close as possible the target weight,
c) transferring the portions from the selected transfer chambers (26) to a hopper (32),
d) repeating the steps b)-c).

8. The method as set forth in claim 7,
characterized in that step c) is followed by the following step:
cd) filling the selected respective transfer chambers (26) with a new weighed portion from a weighing bowl (18);
d′) repeating the steps b)-cd).

9. The method as set forth in claim 7,
characterized in that step c) is executed as follows:
c1) opening the locking system (28) of all the selected transfer chambers (26) and
c2) closing said locking system of each of the selected transfer chambers (26) once the portion has left said transfer chamber (26).

10. The method as set forth in claim 9,
characterized in that the selected transfer chambers (26) open simultaneously in step c1).

11. The method as set forth in claim 9,
characterized in that the selected transfer chambers (26) open one after the other in step c1).

12. The method as set forth in claim 7,
characterized in that the steps c1) and cd) begin at the same time.
